(19) United States
(12) Patent Application Publication
(10) Pub. No.: US 2005/0246940 A1
(43) Pub. Date: Nov. 10, 2005

(54) Fishing lure for sinking presentation

(76) Inventors: Keith Jones, Spirit Lake, IA (US); Chris Pitsilos, Spirit Lake, IA (US); Keith L. Ostrum, Spirit Lake, IA (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/840,427

(22) Filed: May 7, 2004

(51) Int. Cl. A01K 85/14; A01K 85/00

(52) U.S. Cl. 43/42.5; 43/42.39; 43/42.47

(57) ABSTRACT

An undulating fishing lure frame that maintains its horizontal disposition while sinking. The lure frame includes a bent, cupped blade that may have an attachment eyelet for securing a fishing line at the fore end, a hook fastened to the aft end of the blade, and a weighted material at the aft end of the blade. Soft-bodied baits, both natural and artificial, of various shapes, sizes, colors, and actions can be attached to the hook portion of the lure frame to further enhance the lure's visual and/or mechanical appeal to fish.

### FIELD OF THE INVENTION

The invention relates to blade-bearing fishing lures that include a hook and a blade and which may be used with live or artificial baits secured on the hook.

### BACKGROUND

Predatory fish feed effectively by detecting and capturing prey through a variety of senses, including vision (mediated through the eyes) and mechanoreception (mediated through the inner ears and lateral lines.) Both vision and mechanoreception can be used to detect prey organisms that swim horizontally as well as those that descend vertically from above. Fish eyes in particular are adept at detecting both horizontal and vertical motions, since their retinal fields contain a diversity of functional units directionally sensitive to motions along specific planes.

Fish have no innate aversion to hooks, so they can often be caught on hook and line by anglers offering lures and baits that emulate natural prey or produce other alluring sensory patterns. It is not uncommon for anglers to use a variety of techniques and lure types in a typical fishing adventure in order to determine the particular combination of lure and technique that induce a bite or attack response by the local fish.

While both horizontal and vertical lure/bait presentations are abundant, horizontal presentations tend to dominate, especially in those fishing styles that rely on repetitive casting and retrieving. This directional bias is based, in part, on the consideration that most popular freshwater gamefish like black bass (genus Micropterus), crappie (genus Pomoxis), walleye (genus Stizostedion), and trout (genera Onchorhynchus, Salmo, and Salvelinus), and saltwater gamefish like redfish (genus Sciaenops), seatrout (genus Cynoscion), snook (genus Centropomus), and jacks (genera Carangus and Trachurus) are strong piscivores (they feed on small prey fish). These prey fish tend to swim primarily along the horizontal axis. Thus, the logic goes, more effective stimulation of attack behaviors should occur when lures mimic the horizontal presentation and movements of the prey fish.

Lures that have been designed for horizontal presentation by cast/retrieve techniques are characterized by a relatively heavy weight in the front of the lure near the attachment point for the fishing line. A common example is known as a “lead head” lure having a shaped mass of lead around an eyelet and a hook extending from the mass. Lead head lures may or may not also include a front bill and are designed to balance the upwardly directing forces during active lure retrieval with weight urging the lure downwardly. See, U.S. Pat. Nos. 1,997,900; 2,005,554; 2,605,574; 3,187,457; 3,410,020; 4,660,318; 4,738,047; 4,862,629; 5,216,830; and Published Application U.S. 2001/0045048. Casting lures that do not have submerging weights may be buoyant (see, U.S. Pat. No. 4,141,171) or use shaped blades or vanes to induce the desired motion during retrieval. See, U.S. Pat. Nos. 2,218,259 and 2,481,710.

Yet, research on fish behavior has shown that many predators, like those mentioned above, are also very receptive to prey, lures, and baits descending slowly from above. In particular, it would be advantageous to have a fishing lure designed to slowly sink vertically while maintaining a horizontal disposition. Lures that descend in such manner would essentially cut a broader swath through a predatory fish's visual field than lures that fall vertically oriented (i.e. head or tail downward), thereby invoking greater excitement in the fish. Additionally, a slow sinking, horizontally-disposed lure would remain longer in the preferred strike zone of the predatory fish, again providing greater excitement and more opportunity to evoke strikes.

However, as detailed herein, the relative advantage lent by a slowly sinking, horizontally-disposed lure would be highly dependent on the lure rate of fall. Neither lures that sink too slow nor those that sink too fast would be as effective as one that sinks at a more preferred rate. Thus, although U.S. Pat. No. 3,126,661 describes a black bass lure that remains upright and horizontal upon splashdown and sinks very slowly, the primary design intent is to keep the lure near the water's surface, notably while fishing heavy aquatic vegetation. Likewise, U.S. Pat. No. 4,660,318 describes a bladed body equipped with a heavily weighted keel. The invention is primarily meant to be retrieved horizontally but will sink rapidly (>1 ft/sec) when allowed to free-fall through the water column.

### SUMMARY OF THE INVENTION

It is an objective of the present invention to disclose an improved means of stimulating gamefish to strike a vertically descending lure.

Another objective of the current invention is to disclose a means of causing the vertically descending lure to fall slowly, thus prolonging its vertical fall and keeping the lure in the fish's strike zone longer.

Moreover, the invention is intended to disclose a means of equipping the lure to maintain its horizontal disposition while falling vertically.

It is also intended for the invention to disclose a means of causing the lure to undulate with an enticing motion during its vertical descent.

And finally, the current invention provides a means of further enhancing the angling effectiveness of the lure by providing for the addition of natural or artificial prey bodies that, in combination with the lure, offer the target fish a more alluring sensory presentation.

Fishing lures according to the invention comprise a lure frame comprise:
a cupped and curved blade having a fore end, a weighted aft end that is disproportionately heavier than said fore end, a top side, and a bottom side, wherein said blade is cupped by a crosswise bend having a first radius of curvature about a first longitudinal axis and said blade is curved by a lengthwise bend having a second radius of curvature about a first transverse axis;
a hook attached to the weighted aft end of said blade wherein said hook is disposed at an obtuse angle relative to said longitudinal axis, said hook having a forward end attached to said blade and a rearward end exhibiting a curved barb,
whereby the weighted aft end of said blade comprises less than 50% of the total lure weight, and said lure maintains a horizontal orientation while attached to a slack line and sinking through water. Preferably, the lure sinks at a rate that falls within a range of about 0.4-0.98 feet per second to mimic closely the behaviors of swimming prey fish and/or to elicit an aggressive response from predatory fish able to detect the movements.

Careful behavioral research on a variety of predatory game fish has allowed the discovery that predatory receptivity for descending lures is enhanced when the object falls vertically while keeping its long axis in a horizontal disposition. The alluring nature of this presentation is further increased when the vertically-falling, horizontally-oriented lures possess an undulating motion in which the object moves repetitively back and forth, side to side, or in random combinations thereof. Lures of the present invention are designed to exhibit this motion when used in a jig-and-sink fishing technique for enhanced effectiveness in eliciting fish bite behaviors.

### BRIEF DESCRIPTION OF THE DRAWINGS

FIG. 1 is a view of a lure frame according to the invention from several aspects: A) side view; B) overhead view; C) overhead view, slightly rotated; D) bottom view, slightly rotated.

FIG. 2 is an overhead view of the invention showing an assortment of various acceptable blade sizes and configurations.

FIG. 3 is a view of the invention showing an assortment of various acceptable weight configurations: A) a basic, amorphous weight configuration; B) a weight configuration with an added hook eyelet; C) a formed weight with the soft plastic bait molded over the weight for improved bait retention; D) a formed weight overlaid with a plastic molded fish head to which the soft plastic bait abuts.

FIG. 4 is a view of the invention equipped with a natural baitfish (alive or dead) on the hook: A) side view; B) overhead view, slightly rotated; C) bottom view, slightly rotated.

FIG. 5 is a view of the invention equipped with an assortment of popular soft plastic bait shapes attached to the hook: A) the invention with a basic soft plastic fish; B) the invention with a soft plastic fish with a swimming tail; C) the invention with a swimming tail grub; D) the invention with a nightcrawler imitation; E) the invention with a swimming tail worm; F) the invention with an eel.

### DETAILED DESCRIPTION

Prior lure designs, such as standard jig heads and “lead head” lures, traditionally employ weighting arrays and shape configurations that over-power vertical drag forces, causing the lures to sink too quickly and in a vertical orientation. By contrast, the lure frame according to the present invention maintains a slow descending, horizontal orientation when falling through the water based on a model having a horizontal lever with two extended arms (blade and hook) and a weighted fulcrum (weighted bend in aft end of blade). The weighted fulcrum pulls the lure frame downward while the two arms—the blade and hook—serve to counteract this motion through hydrodynamic drag, thereby holding the lure frame so that the blade portion sinks at an angle that is substantially perpendicular to the sinking direction, i.e., the blade sinks in a substantially horizontal orientation with random lateral undulations. The downward pull of the fulcrum weight and the opposing drag forces of the extended arms are balanced to provide a lure frame that falls slowly, yet horizontally through the strike zone of a game fish and better elicits a bite response.

Through the use of proper weighting and blade profile, lure frames according to the invention: (a) slow the rate of lure fall, thereby keeping the lure in the fish's strike zone longer; (b) allow the lure to maintain a horizontal orientation while falling through the water with a slack line attached to the fore edge of the blade; and (c) exhibit an undulatory motion which, in turn, conveys this motion to any soft-bodied bait attached to the hook of the lure frame.

In its simplest form, the lure frame comprises a cupped blade having a line attachment at a fore end, a bent aft end of the blade, and a hook secured to the bent aft end of the blade. A measured amount of a relatively heavy weighting material, preferably a molten metal such as lead, can be added to the bent portion of the blade where the hook is secured to the blade. In other embodiments, the weighting material can be in a thickened part of the blade which may have an opening into which the hook shaft inserts, or the weighting material can be shaped with a barb to provide improved retention for a soft bait threaded over the hook or overlaid onto the lure frame, a more realistic prey fish head shape, or enhanced aesthetic appeal or improved lure functions.

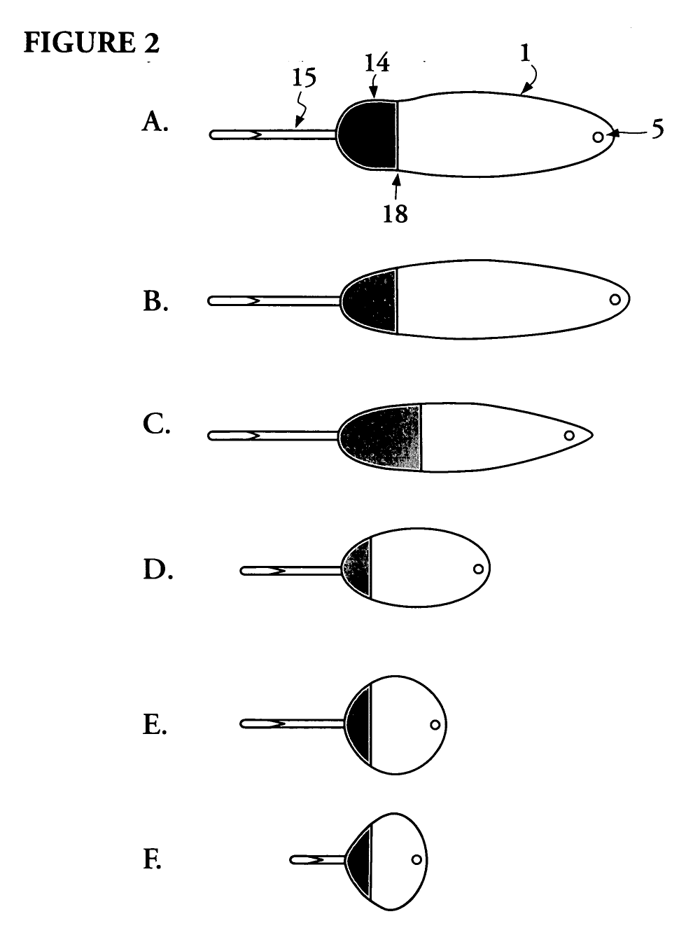

The blade portion of the lure frame according to the invention can be of an assortment of shapes and sizes. Exemplary forms are shown in FIG. 2 and include (from top to bottom) rounded ovals that are long (FIG. 2A and FIG. 2B) or short (FIG. 2D), pointed teardrop shapes (FIG. 2D), circular (FIG. 2E), and those that are more broad than long (FIG. 2F). The examples shown are, of course, in no way intended to be a complete representation of all possible blade shapes and sizes suitable for the invention. Those skilled in the art will recognize the myriad assortment of other blade configurations that will also yield varying degrees of acceptable performance.

The blade portion of the lure frame is also provided with an eye in the fore end of the blade and ringlet passing through that eye for attaching a fishing line thereto.

The hook portion is secured to the bent aft portion of the blade by soldering, welding, or other forms of permanent attachment.

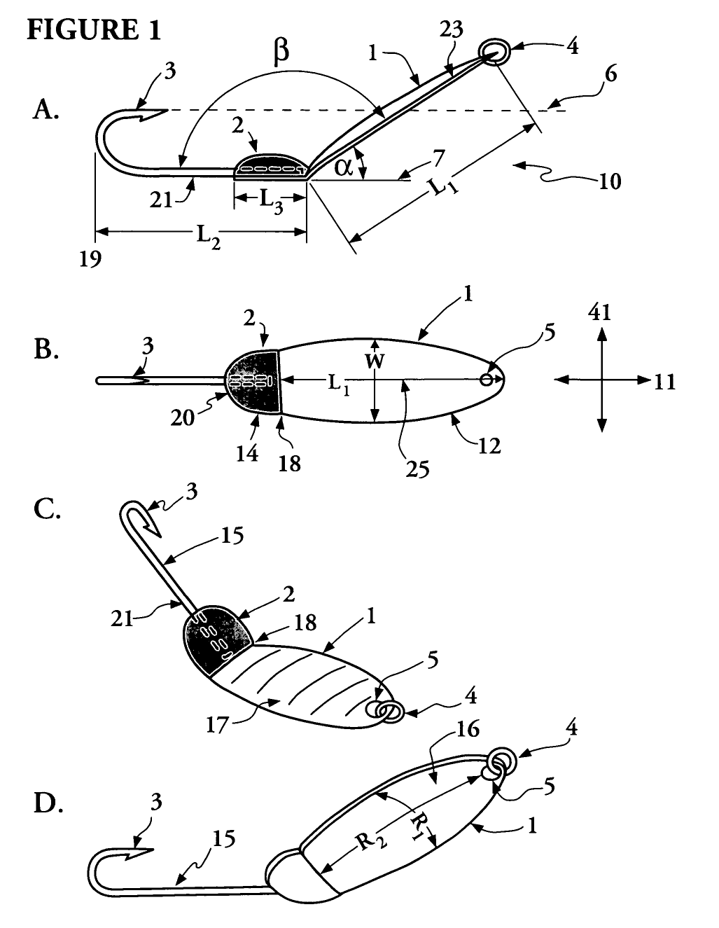

The blade is cupped by arcuate bends along two radii of curvature: a first radius of curvature about the longitudinal axis and a second radius of curvature about a transverse axis, which may or may not be the same length, but which are around axes located on the same side of the blade. Preferably, the first radius of curvature (R1 in FIG. 1D) is within the range from about 0.5 to 4.0 inches and most preferably within the range from about 0.7 to 1.5 inches. Preferably, the second radius of curvature (R2 in FIG. 1D) is within the range from 1 to 10 inches and most preferably within the range from about 2.2 to 7.3 inches. These bends form a concave first surface and a convex second surface on the blade. The lure frame can be assembled to present the concave surface either towards or away from the hook barb.

The blade is preferably made from brass, steel, stainless steel, hardened plastic, ceramic or other stiff materials suitable for exposure to typical fishing conditions. Preferred blades have a thickness within the range of 0.010 to 0.100 inches and most preferably within the range of 0.020 to 0.050 inches. Blades can be chromed or polished to have brilliant reflection as well as painted or otherwise decorated for greater visual/aesthetic appeal.

The aft end of the blade is bent and preferably flattened to serve as a point of attachment for the hook as well as a support for added weight material. The bend should be made in the blade at a length that is 65-85% (preferably 75-80%) of the blade's total original length starting from the fore end of the blade. The blade is bent to an angle within the range from about 25° to 40° positive to the hook shank, preferably within the range from about 30° to 35°, and especially at an angle of about 33°. The resulting blade will exhibit the complementary obtuse angle that is formed between the longitudinal axis of the remaining cupped blade and the longitudinal axis of the bent surface that is within the range from about 140° to 155°, preferably within the range of 145° to 150°, and especially at about 147°.

The hook used in the lure frame of the invention can be any of the hooks commonly used in connection with fishing and include a linear, or offset linear shank portion and a barbed hook portion. It will be understood by those in the art that the size of the hook will be balanced with the size of the blade. Standard fishing hooks useful in the lure frame of the present invention have a diameter within the range from about 0.015 to 0.065 inches. Hooks with an offset shank that also include a terminal eyelet that lies above the attachment site to the bent portion of the blade and any added weight material allow for a second line attachment point.

The amount and distribution of weight material on the bent portion of the blade, relative to the weight of the remaining hook and cupped blade components helps to provide the desired lure frame orientation as the lure frame sinks through water. The amount of weight material added to the lure frame should constitute less than about 50% of the total lure frame weight, preferably within the range of about 15-35%, and even more preferably within the range from about 19-31%. Relatively simple trial and error that requires no more than the routine exercise of the existing level of ordinary skill in the art will readily determine the specific amount of weight material to add to the bent aft portion of the blade to produce the desired vertical sinking rate while maintaining a substantially horizontal lure frame blade orientation (i.e., the blade portion to which the hook is not attached remains substantially perpendicular to the direction of sinking with random lateral undulations). Suitable sinking rates fall within the range of about 0.4 to about 0.98 feet per second (fps) and preferably within the range of about 0.5 to about 0.97 fps, and more preferably within the range of 0.71 to 0.97 fps.

The added weight material can be amorphous (e.g. a pool of lead solder) or shaped to have a specific look or function (e.g. to enhance soft bait retention using a formed barb), designed to let the soft bait be easily over-molded (i.e. injection molded over a fixture) as during commercial production, or designed to simulate a specific shape (e.g. the head of a prey fish). The added weight can be located either above or below the concave surface of the blade and can be applied externally to the blade or simply integrated directly into the blade itself. Weight can also be overlaid with a secondary layer (e.g. hardened plastic) that itself may be shaped and/or decorated for a more appealing look.

The invention is conveniently described with reference to the attached figures. FIG. 1 illustrates lure frame 10 from several perspectives. Blade 1 is oblong with an extended length along longitudinal axis 11 that passes through centerline 25, opening 5 in fore end 12, across bend 18 formed in aft end 14 of blade 1, and along the length of hook 15 to barbed end 3. Attachment ring 4 may be threaded through opening 5 and can be used for securing a fishing line or fishing line connector thereto.

Blade 1 exhibits left-right curvature having a first radius of curvature R1 along longitudinal axis 11 and fore-aft curvature having a second radius of curvature R2 about along transverse axis 41. Preferably, first radius of curvature R1 is within the range from about 0.5 to about 4.0 inches. Second radius of curvature is preferably within the range from about 2.2 to about 7.3 inches with a ratio of R2:R1 preferably within the range of about 1:1 to about 5:1. The radii of curvature should be from a point located on the same side of blade 1 to form a concave first surface 16 and convex second surface 17 on blade 1. When lure frame 10 is assembled, concave first surface 16 may be disposed either towards or away from hook 15.

Bend 18 is located at a first length L1 from fore end 12. A second length, L2, extends from bend 18 to apex 19 of hook 15. Third length L3 extends from bend 18 to the aft end of blade 1. Bend 18 is formed into blade 1 so that length L1 represents roughly 65-85% the total length of blade 1 (length L1 and length L3). Shaft 21 of hook 15 is secured to blade 1 by welding, soldering, or similar permanent connection techniques to bent aft portion 14 of blade 1. In another way of looking at the configuration is that the hook is secured to the aft end of the blade so that a ratio of (a) a first length between the bend and the fore end of the blade; and (b) a second length between the bend and apex 19 of the attached hook is desirably within the range from about 0.85 to about 1.25, preferably within the range of 0.9 to about 1.1.

Added weight material 2 is then applied to bent aft portion 14 in an amount sufficient to cause lure frame 10 to sink with fore end 12 in a substantially horizontal orientation while producing an undulating lateral motion intermixed with random glides resulting from dynamic interaction with the water. The amount of added weight material 2 should be less than about 50% of total lure frame weight in the absence of any externally attached soft bait or bait-shaped mass.

Aft portion 14 is bent at an angle sufficient to provide hydrodynamic stability as lure frame 10 sinks through water with slack fishing line attached to attachment ring 4. Relative to second longitudinal axis 7 of hook shank 21 and aft portion 14 as extended below blade 1, bend angle α is within the range from about 25-40°, preferably within the range from about 30-35°, with an especially preferred angle of about 33°. Measured from aft portion 20 to the outer rim 23 of blade 1, the complementary bend angle β is within the range from about 140° to 155°, preferably within the range from about 145° to 150°, with an especially preferred angle of 1470.

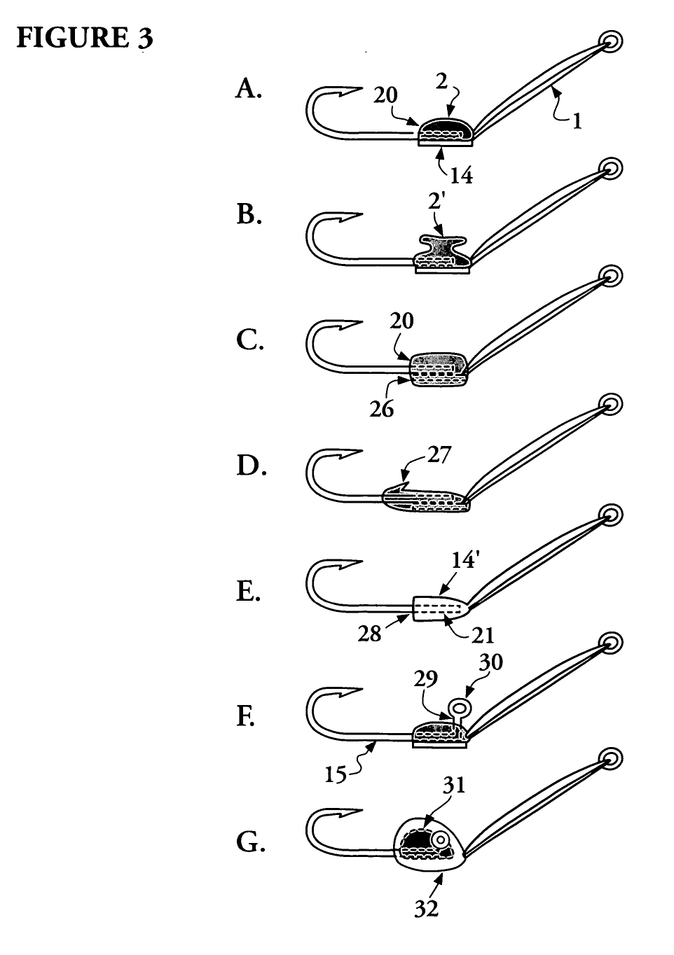

FIGS. 3A-3G depict various dispositions, configurations, and shapes for added weight material 2 on aft portion 14. FIG. 3A shows a mound of lead solder in a hemispherical shape on top 20 of aft portion 14. FIG. 3B illustrates weight material 2′ in a shaped anvil configuration also on top 20 of aft portion 14. FIG. 3C depicts weight material 2 in a cylindrical shape that has been cast or spun around top 20 and bottom 26 of aft portion 14. FIG. 3D presents weight material 2 in a soft bait retention shape having a forward projecting soft bait barb 27 pointing toward blade 1 so as to hook into soft bait body material above soft bait barb 27. FIG. 3E contemplates an aft portion 14′ that is formed to be relatively thicker than blade 1 and into which is formed pocket 28 that can receive hook shank 21. FIG. 3F shows a hook 15 with perpendicular bend portion 29 that terminates in eyelet 30 which provides a second point for attaching a fishing line. FIG. 3G illustrates weight material 2 in the shape of a prey fish head 31 with a colored overlay of hard plastic 32 that adds details.

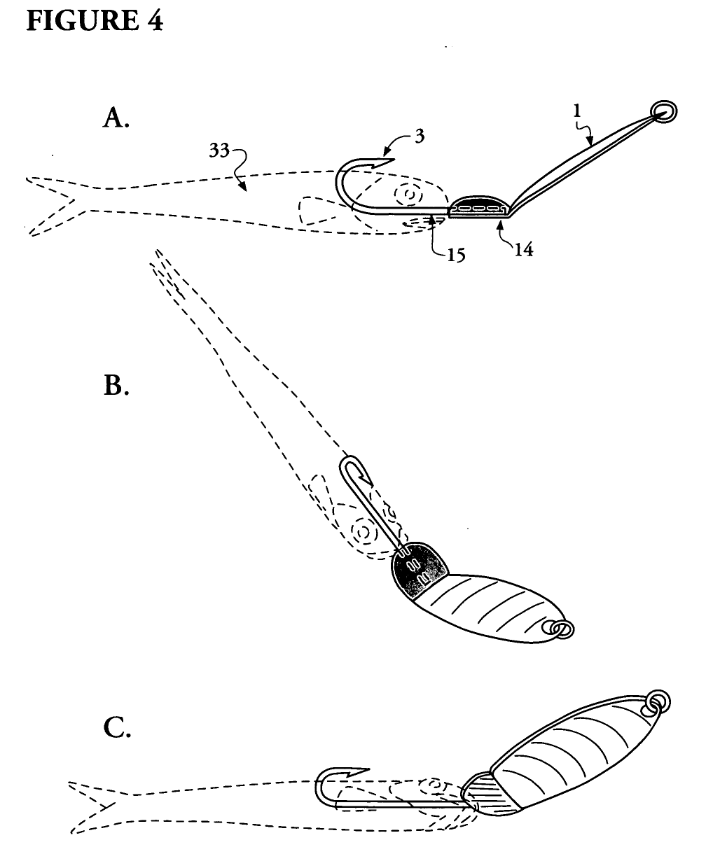

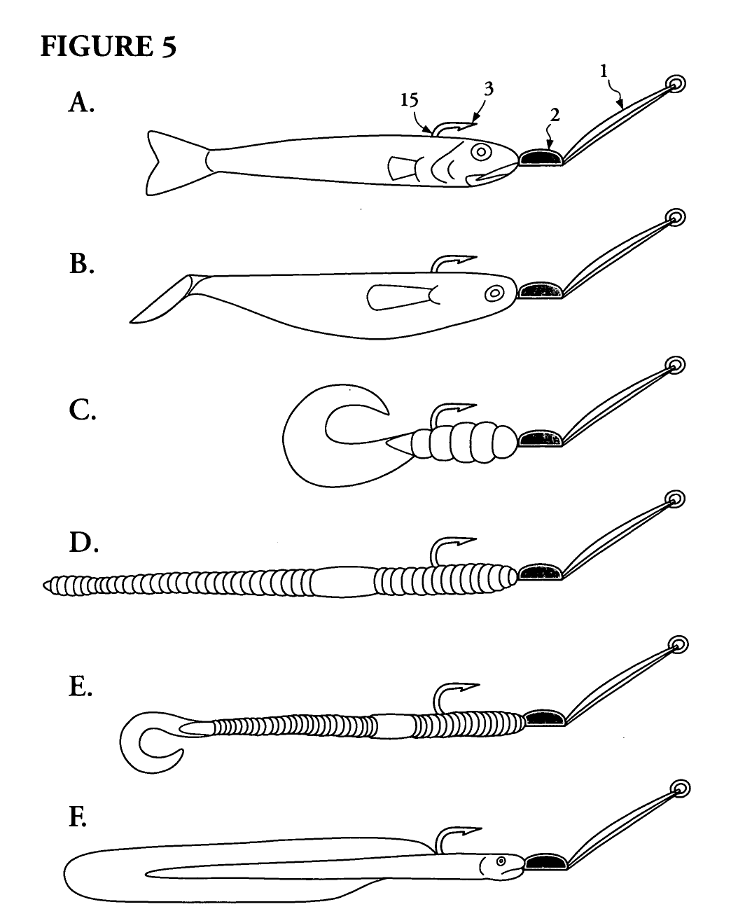

FIGS. 4 and 5 illustrate the lure frame of the invention with various types of bait bodies. FIG. 4 shows side (FIG. 4A), top (FIG. 4B), and bottom (FIG. 4C) views in which a live or dead prey fish 33 has been threaded onto hook 15 that has been mounted on aft portion 14 to present barb 3 upwardly toward blade 1. FIG. 5A depicts a soft-bodied plastic minnow-shaped bait body rigged onto hook 15. Similarly, lure frame 10 can be rigged with other artificial baits including a soft-bodied bait body with a swimming tail (FIG. 5B), a swimming tail grub (FIG. 5C), an artificial nightcrawler (FIG. 5D), an artificial worm with a swimming tail (FIG. 5E), and an imitation eel (FIG. 5F).

### EXAMPLE

A fishing lure according to U.S. Pat. No. 4,660,318 was made and compared to a lure according to the present invention. Both lures were attached at their front ends to a slack fishing line, rigged with the same artificial soft bodied bait, and allowed to sink through 11.9 feet of water in a tank. The times required for the lures to reach the tank bottom starting from the surface were measured over 10 trials for each lure and the average sink rate in feet/sec calculated. The movements of each lure were also noted.

The lure according to the '318 patent had about 76% of its total weight concentrated in the weighted keel located beneath the aft portion of the blade. By contrast, the lure according to the present invention provided a blade weight of about 26% of the weight located on the bent aft portion of the blade.

The lure according to the '318 patent sank at a rate of 1.16 feet/second, roughly 16% outside the preferred sink rate window. The lure according to the present invention sank at an average rate of 0.76 feet/second, i.e. roughly 35% slower than the patent '318 lure and well within the preferred sink rate window. For point of comparison, a typical lead head jig was tested and sank at a rate of about 2.35 ft/second, i.e. roughly 3.1 times faster than the present invention.

Besides its faster rate of fall, the lure according to the '318 patent suffered a reduction in its oscillatory action and random glides due to the motion dampening effects of its heavy keel. The lure according to the present invention exhibited considerably more oscillatory undulations, punctuated with lateral random glides, with the lure frame remaining continually in a substantially horizontal disposition. Consequently, the action of the present invention more closely resembled the natural motions of a swimming prey.

1. A bladed fishing lure comprising a lure frame comprising:
a. a cupped and curved blade having a fore end, a weighted aft end that is relatively heavier than said fore end, a top side, and a bottom side, wherein said blade is cupped by a crosswise bend having a first radius of curvature about a first longitudinal axis and said blade is curved by a lengthwise bend having a second radius of curvature about a first transverse axis, and
b. a hook attached to the weighted aft end of said blade wherein said hook is disposed at an obtuse angle relative to said longitudinal axis, said hook having a forward end attached to said blade and a rearward end exhibiting a curved barb,
whereby the weighted aft end of said blade comprises less than 50% of the total lure frame weight and said lure frame maintains a horizontal orientation while attached to a slack fishing line and sinking through water.

2. A lure according to claim 1 wherein said blade is cupped and curved to form a concave surface.

3. A lure according to claim 2 wherein said concave surface opens toward said barb.

4. A lure according to claim 2 wherein said concave surface opens away from said barb.

5. A lure according to claim 1 wherein said first radius of curvature is within the range from about 0.5 inches to about 4 inches.

6. A lure according to claim 1 wherein said first radius of curvature is within the range from about 0.7 inches to about 1.5 inches.

7. A lure according to claim 1 wherein said second radius of curvature is within the range from about 1 inch to about 10 inches.

8. A lure according to claim 1 wherein said second radius of curvature is within the range from about 2.2 inches to about 7.3 inches.

9. A lure according to claim 1 wherein said obtuse angle is within the range from about 140° to about 155°.

10. A lure according to claim 1 wherein said obtuse angle is within the range from about 145° to about 150°.

11. A lure according to claim 1 wherein said obtuse angle is formed by a bend in the aft end of said blade.

12. A lure according to claim 11 wherein said bend is formed about a second transverse axis at a distance of about 65-85% of total blade length from said fore end of said blade.

13. A lure according to claim 11 wherein said bend is formed about a second transverse axis at a distance of about 75-80% of total blade length from said fore end of said blade.

14. A lure according to claim 11 wherein said hook is secured to the bent aft end of said blade.

15. A lure according to claim 1 wherein said hook has a straight shaft.

16. A lure according to claim 1 wherein said hook has an offset shaft and an eyelet at its forward end that provides an attachment point for securing fishing line to said lure.

17. A lure according to claim 1 wherein said weighted aft end comprises a weighting material applied to said aft end of said blade.

18. A lure according to claim 17 wherein said weighting material exhibits a useful shape.

19. A lure according to claim 18 wherein said useful shape comprises a soft bait retention barb.

20. A lure according to claim 18 wherein said useful shape mimics a head or body part of a natural prey.

21. A lure according to claim 1 wherein said blade has a width along said first transverse axis that is greater than its length along said longitudinal axis.

22. A lure according to claim 1 wherein said blade has a width along said first transverse axis that is less than its length along said longitudinal axis.

23. A lure according to claim 1 wherein said blade has a width along said first transverse axis that is substantially equal to its length along said longitudinal axis.

24. A bladed fishing lure comprising a lure frame consisting of:
a. a cupped and curved blade having a fore end, a weighted aft end that provides an uneven weight distribution profile to said blade, a top side, and a bottom side, wherein said blade is cupped by a crosswise bend having a first radius of curvature about a first longitudinal axis and said blade is curved by a lengthwise bend having a second radius of curvature about a first transverse axis, and
b. a hook attached to the weighted aft end of said blade wherein said hook is disposed at an obtuse angle relative to said longitudinal axis, said hook having a forward end attached to said blade and a rearward end exhibiting a curved barb, whereby said lure frame sinks through water at a rate of less than 1 foot per second and maintains a horizontal disposition angle while attached to a slack fishing line.

25. A fishing lure according to claim 24 wherein said lure frame sinks at a rate within the range from about 0.4 to about 0.98 feet per second.

26. A fishing lure according to claim 24 wherein said lure frame sinks at a rate within the range from about 0.71 to about 0.97 feet per second.

27. A fishing lure according to claim 24 wherein said obtuse angle is formed by a bend in the aft end of said blade about a second transverse axis at a distance of about 65-85% of total blade length from said fore end of said blade.

28. A fishing lure according to claim 27 wherein said hook is secured to said aft end so that a ratio of: (a) a first length between said bend and said fore end of said blade; and (b) a second length between said bend and the rearward end of the attached hook is within the range from about 0.85 to about 1.25.

29. A fishing lure according to claim 28 wherein said ratio is within the range from about 0.9 to about 1.1.
